(19) United States
(12) Patent Application Publication
(10) Pub. No.: US 2009/0034654 A1
(43) Pub. Date: Feb. 5, 2009

(54) Dynamic multiplexing and de-multiplexing technique with enhanced synchronization

(75) Inventors: Thomas Inukai, Gaithersburg, MD (US); Anil Agarwal, North Potomac, MD (US); Mark Miller, Vista, CA (US)

Correspondence Address: SUGHRUE MION, PLLC, 2100 PENNSYLVANIA AVENUE, N.W., SUITE 800, WASHINGTON, DC, 20037, US

(73) Assignee: VIASAT INC., Carlsbad, CA (US)

(21) Appl. No.: 11/882,643

(22) Filed: Aug. 3, 2007

(51) Int. Cl. H04L 27/00

(52) U.S. Cl. 375/299; 455/59; 370/470

(57) ABSTRACT

A communication system having a first station and a second station in communication over a wireless communications link. The first station is operative during a communication session to assemble signals from multiple data sources into a common data stream and to transmit the data stream as frame-based communication signals to the second station. The first station comprises a dynamically configurable multiplexer that is operative during a communication session (1) to generate the common data stream by multiplexing the signals in accordance with a plurality of control parameters and assemble said signals according to frames, (2) to dynamically modify the plurality of control parameters in accordance with changes in wireless link conditions and (3) to generate control signals identifying modifications to the control parameters. The first station is operative to transmit to said second station the signals assembled according to frames and the control signals

### STATEMENT REGARDING FEDERALLY SPONSORED RESEARCH OR SPONSORSHIP

The invention described herein was supported by funding from the U.S. Government under Contract No. DAAB07-03-D-C211. The U.S. government has certain rights.

### BACKGROUND OF THE INVENTION

High volume and reliable communication between terminals via satellite, wireless or even wired links is desired throughout the world. In satellite systems, the terminals may communicate through C-band, Ku-band, and Ka-band non-regenerative transponders on satellites in a geo-stationary orbit. The use of bandwidth efficient modems in such environments is well known. The modems may use a variety of encoding techniques, including Turbo coded and 16-ary modes of operation. In addition to Turbo code and 16-ary modulation, the receiver can implement (1) self configuration and (2) Information Thru-put Adaptation (ITA). The former enables the receive modem to be configured from information resident in the waveform. The operator only needs to enter the symbol rate. The later allows modems on either end of the link to “negotiate” the highest possible data rate constrained to a fixed symbol rate and further adapt this data rate to changing link conditions.

FIG. 1 illustrates a block diagram of a conventional satellite-based communication system using two modems 4A, 4B, each located at a respective station A, B. Each station comprises a terminal 1A, 1B, also having conventional amplifier, conventional multiplexer and conventional encoding capabilities, as well as an antenna 5A, 5B, respectively. The modems 4A, 4B are illustrated as modules coupled to other components of the terminals 1A, 1B, respectively, as an independent unit or integrated structure, between a source or destination for user information and control data and an antenna 5A, 5B, respectively. The modem is adapted to modulate a carrier wave, which is generated at the terminal 1A, 1B and transmitted by the antenna 5A, 5B, with the user information and control data, using well known techniques such as BPSK, QPSK, 8-PSK and 16-APSK. The modem also may encode the data according to techniques known to minimize losses and enhance accuracy, such as Viterbi and/or other codes at exemplary rates ½, ⅔, ¾, ⅞, 19/20. Further, the modem may demodulate a carrier wave received by the antenna, and strip away the data and information from the carrier wave, making the data and information available for further processing.

In the illustrated conventional system, the user information and control data 2A that is input to user terminal 3A is first processed (encrypted, multiplexed, etc.) and then appended onto a carrier wave by modem 4A for transmission by antenna 5A to the satellite 6. The signal relayed by satellite 6 is received by antenna 5B, demodulated at modem 4B and processed (decrypted, demultiplexed, etc.) at user terminal 3B so that data and information 2B can be delivered for further processing. In bi-directional communications, modem 4B may also be used to modulate a carrier wave for transmission of data and information via the satellite 6, and modem 4A may be used to demodulate a received carrier wave for reception of those signals.

In the system illustrated in FIG. 1, the modem may be operative in response to fixed waveform parameters, such as symbol rate, type of waveform (modulation, coding) and data rates. In such case, both modems 4A and 4B are initialized and maintained with the same set of configuration parameters. Alternatively, as disclosed in co-pending application to Agarwal et al, entitled Enhanced Bandwidth Efficient Modem, filed concurrently with the present application and assigned to the same assignee as the present application, the entire content of which is incorporated herein by reference, the user data rate may be changed dynamically, i.e., while communicating modems are on-line. Such rate adaptive modems permit a variation of data rates, for example a lowering of the rate under adverse link conditions, as indicated by the rain cell 10, in order to maintain reliable communications.

The transmitted information may comprise a variety of types and may be implemented at a variety of rates. For example, the waveform may be used to transport three types of information: i) overhead channel data, ii) embedded channel data, and iii) user data. All three data sources originate from the transmitting modem and are multiplexed. The overhead channel is established by multiplexing overhead data in with the user data stream. The overhead data typically originates and terminates at the user equipment, e.g., a telephone handset, a personal digital assistant (PDA), etc. The data rate for the overhead channel may be a fixed rate. The data rate for an exemplary overhead channel may be selectable from 0 to 64 kbps in 8 kbps increments. However, the present invention is not limited to this range and increment. Preferably, but not necessarily, when the conventional information throughput adaptation (ITA) technique is used, a primary overhead channel data rate does not change. ITA techniques are disclosed in METHODS AND APPARATUS FOR SATELLITE LINK THROUGHPUT ADAPTATION, WO/2003/026189, and their application to environments subject to signal degradation is disclosed in METHODS AND APPARATUS FOR MITIGATING RAIN FADING OVER SATCOM LINKS VIA INFORMATION THROUGHPUT ADAPTATION, U.S. Pat. No. 7,174,179.

The embedded channel is used in, for example, modem-to-modem communications. The embedded channel data originates and terminates within the respective modems. The embedded channel may be used to support applications such as distance end monitoring (DEM) and ITA. However, the embedded channel is not limited to just these applications. Preferably, but not necessarily, the data rate of the embedded channel, when enabled, is greater than or equal to 4 kbps. When ITA is enabled, the embedded channel data may change, but, preferably, the embedded channel data rate is kept greater than or equal to 4 kbps.

The user data channel is employed for transporting an external data stream, which may be presented at the I/O port of the modem. Exemplary, but non-limiting, user data channel data rates that may be present at the I/O port of a modem are provided in Table 1 below.

TABLE 1

| Modulation | Minimum Data Rate | Maximum Data Rate |
|---|---|---|
| BPSK | 64 kbps | Min(60.00 Mbps, h) |
| QPSK | 64 kbps | Min(120.00 Mbps, h) |
| 8-PSK | 256 kbps | Min(155.52 Mbps, h) |
| 16-APSK TCM | 256 kbps | Min(52.84 Mbps, h) |
| 16-APSK (Turbo) | 256 kbps | Min(155.52 Mbps, h) |

The parameter h is the maximum data rate that can be selected for the given waveform parameters (modulation, FEC parameters, overhead channel configuration, etc.) constrained to the symbol rate being less than or equal to 60 Msps. When the user data rate is an entered parameter, it may be entered with a resolution of 1 bps and the symbol rate is calculated by the modem.

Consistent with the foregoing data rates, symbol rates from 32 ksps to 60 Msps may be employed. When the symbol rate is an entered parameter, it may be entered with a resolution of 1 Hz and the modem calculates the user data rate. When the link is set up to operate in information rate adaptation mode, the symbol rate is always the entered parameter. The symbol rate remains constant during information rate adaptation.

As disclosed in the co-pending application to Agarwal et al, entitled Enhanced Bandwidth Efficient Modem, filed concurrently with the present application, an application that allows modems on either end of the link to “negotiate” the highest possible data rate using a predefined symbol rate and further adapt the data rate to changing link conditions is found in the Information Throughput Adaptation (ITA) system. In the ITA system, the transmitting signal consists of a continuous stream of symbols at the rate of R_{sym} symbols per second. The continuous symbol stream is broken up into ITA frames as shown in FIG. 2A. Other arrangements that divide information streams into time divided frames also can be used, as recognized by those skilled in the art.

FIG. 2A illustrates a format of a time division multiplexed transmission frame 40 of the waveform that may be used with a conventional ITA system and with a system having variable rate multiplexers that are implemented in accordance with the present invention. The transmission frame 40 includes a sync field 41, a header field 42 and a payload field 43. The sync field 41 may have, for example, 64 symbols. The sync field 41 contains the sync word used by the receiving modem for synchronization. After synchronization, the cyclic redundancy check (CRC) field 46 of header field 42, as illustrated in FIG. 2B, may be used to validate frame synchronization. Each payload 43 may contain an integer number, L, of sub-frames 65 (or code blocks). As illustrated in FIG. 2C, each sub-frame 65 may be M bytes in length and may contain K information (uncoded) bits within it. When block FEC encoding is used (e.g., Turbo code or Reed Solomon Code), each sub-frame 65 of data may be associated with one code block. When block FEC encoding is not used, the data may still be grouped into sub-frames of K information bits to support multiplexing operations.

With reference again to FIG. 2B, the header field 42 of the transmission frame 40 may have, for example, 336 symbols. The header field 42 may include a waveform ID field 45, the CRC field 46 and a flush field 47. The header field 42 may convey the waveform details and the transmission frame number. As illustrated in FIGS. 2D and 2E, which provide further detail with respect to the content of the waveform ID 45 in the header 42, the type of coding (e.g., Turbo or TCM), if used, and the associated code block size, K, may be configured in the FEC field 53 and Code Block Size field 54 of waveform ID field 45, as subsequently described with respect to FIG. 2E.

Each sub-frame 65 may contain bytes multiplexed from the overhead channel, the embedded channel, and the user data channel, as illustrated in FIG. 2C. Each sub-frame 65 may comprise, for example, a sub-header field 66, overhead channel field 67 comprising overhead channel data, embedded channel field 68 comprising embedded channel data (when used) and user channel field 69 comprising user channel data. The sub-header field 66 may be, for example, 6 bytes (48 bits) in length and may contain the control information for a multiplexer. The indication of whether the embedded channel is used may be configured in, for example, the embedded channel enabled bit 56 of waveform ID field 45, as illustrated in FIG. 2E.

The waveform ID field 45 of the header 42 may be, for example, 20 bits long. As shown in FIGS. 2D, the 20-bit waveform ID field 45 contains the frame number 50 in frame 40. However, the ID field 45 may also identify waveform parameters. In this regard, the least significant bit (LSB) 51 of waveform ID field 45 doubles as the header type indicator, i.e., using binary or even and odd values. A “0” in this field may, for example, indicate a frame 40 that contains the frame number, and a “1” may indicate a frame 40 that contains waveform parameters.

FIG. 2E illustrates an exemplary 20-bit structure of the waveform ID 45 for a transmission frame 40 containing waveform parameters. The waveform ID field 45 for this frame type may contain, for example, a 3-bit modulation field 52, a 3-bit forward error check (FEC) type/rate field 53, a 2-bit code block size (e.g., the interleaver block size for TCM coding) field 54, a scrambling enabled bit 55, an embedded channel enabled bit 56, a four-bit overhead channel data rate field 57, an ITA enabled bit 58, a receive channel status bit 59 and a header type bit 51. The reserve field 60 may be set to “0”s in the exemplary embodiments of the present invention.

Also, as disclosed in the co-pending application to Agarwal et al, entitled Enhanced Bandwidth Efficient Modem, filed concurrently with the present application, effective Antenna Handover (AH) in satellite communications requires seamless communications with shipboard terminals in the presence of RF signal outages that may occur as antennas are switching, especially in maritime applications.

A problem that is encountered in satellite communications systems, especially those employing ITA and AH applications, is that the multiplexing and demultiplexing parameters may change on the basis of changes in the communications environment.

Yet another problem is that synchronization may be lost under adverse conditions and an insufficient number of synchronization symbols are sent to ensure accurate recovery.

Thus, there is a need for a dynamic multiplexing and demultiplexing scheme that will permit adaptation of the multiplexing process applied to a time divided multiplexed transmission of information, so that efficient and reliable communications can be attained.

There also is a need for a dynamic multiplexing and demultiplexing technique that will permit the effective overwriting of information symbols with synchronization symbols when communications are conducted under adverse conditions, so that effective and reliable communications can be attained.

### SUMMARY OF THE INVENTION

A multiplexing apparatus and method consistent with the present invention provides a multiplexing technique that (1) allows dynamic reconfiguration of multiplexer parameters without loss of data, (2) supports multiple clock sources and different types of timing mechanisms (synchronous, plesiochronous, asynchronous), and (3) maintains bit count integrity (BCI) even in the event of control message errors and a loss of transmission frame marker. The present invention also relates to a de-multiplexing apparatus and method that de-multiplexes the multiplexed data in achieving the foregoing results.

Applications that may use a multiplexing and de-multiplexing apparatuses and methods consistent with the present invention include, but are not limited to, Information Throughput Adaptation (ITA) and Antenna Handover (AH) in satellite communications. ITA allows modems on either end of the link to “negotiate” the highest possible data rate using a predefined symbol rate and further adapt the data rate to changing link conditions. AH allows seamless communications with shipboard terminals in the presence of RF signal outages due to antenna handover.

Thus, the invention concerns a communication system comprising a first station and a second station in communication over a wireless communications link. The first station is operative during a communication session to assemble signals from multiple data sources into a common data stream and to transmit said data stream as frame-based communication signals to said second station. The second station is operative at least to receive the communication signals and reconstruct the signals from the multiple data sources. The first station comprises a dynamically configurable multiplexer that is operative during a communication session (1) to generate the common data stream by multiplexing said signals from multiple data sources in accordance with a plurality of control parameters and assemble said signals according to frames, (2) to dynamically modify the plurality of control parameters in accordance with changes in wireless link conditions and (3) to generate control signals identifying modifications to the control parameters. The control signals are transmitted to the second station so that coherent transmission between stations can be implemented.

The invention also concerns a dynamic multiplexer operative in a communication system having at least a first station and a second station in communication over a wireless communications link. The multiplexer comprises a plurality of input channels, each receiving an input data stream from a respective one of a plurality of data sources. The multiplexer has a framer receiving data from the plurality of input channels and assembling signals from the plurality data sources into a common frame-based data stream. There also is a controller, responsive to information about data at the plurality of input channels, to control the framer to generate the common data stream by multiplexing the signals from the plurality of data sources in accordance with a plurality of control parameters and assemble the signals according to frames. The control parameters are modifiable in accordance with features of the plurality of data sources. The controller generates control signals identifying modifications to the control parameters.

The invention also permits implementation of a dynamic multiplexing and demultiplexing technique that will permit the effective overwriting of information symbols with synchronization symbols when communications are conducted under adverse conditions.

### BRIEF DESCRIPTION OF THE DRAWINGS

The above features and advantages of the present invention will become more apparent by describing in detail exemplary embodiments thereof with reference to the attached drawings in which:

FIG. 1 illustrates a schematic overview of a satellite communication system with user terminals having a conventional arrangement with a modem an antennas that communicate via a satellite.

FIG. 2A illustrates a format of a conventional time division multiplexed frame with subframes.

FIG. 2B illustrates an example of the content of a sub-frame of a time division multiplexed frame.

FIG. 2C illustrates a format of a header within a sub-frame of a time division multiplexed frame.

FIG. 2D illustrates a format of a waveform ID portion of a header.

FIG. 2E illustrates a content of a waveform ID portion of a header.

FIG. 3A illustrates a satellite communications system using a rate adaptive multiplexer and demultiplexer, in accordance with the present invention.

FIG. 3B illustrates a schematic representation of a user terminal with a multiplexing apparatus implemented in accordance with the present invention.

FIG. 3C illustrates a schematic representation of a user terminal with a demultiplexing apparatus implemented in accordance with the present invention.

FIG. 4 illustrates the configuration of a user terminal having a multiplexer in accordance with an exemplary embodiment of the present invention.

FIG. 5A illustrates the configuration of a sub-frame consistent with the present invention.

FIG. 5B illustrates the configuration of the waveform ID field of a transmission frame that contains waveform parameters consistent with the present invention.

FIG. 5C illustrates the relative sizes of various components of a subframe in accordance with the present invention.

FIG. 6A illustrates a process for removing and replacing symbols in a payload with sync symbols when communications are conducted under adverse conditions.

FIG. 6B illustrates a sync symbol generator for generating symbols in accordance with the process of FIG. 6A.

### DETAILED DESCRIPTION OF THE INVENTION

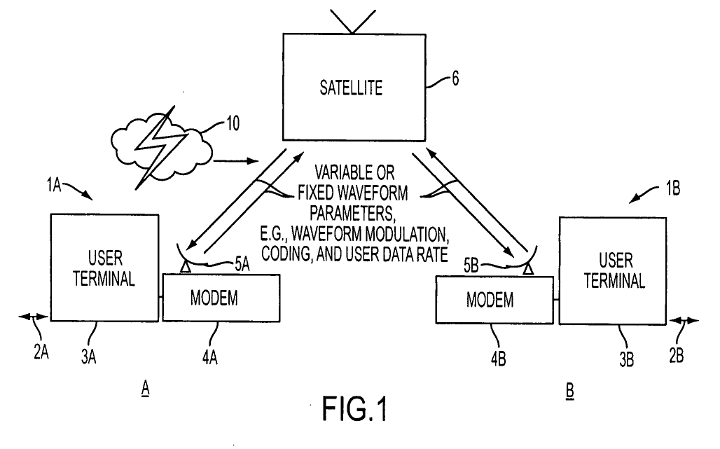

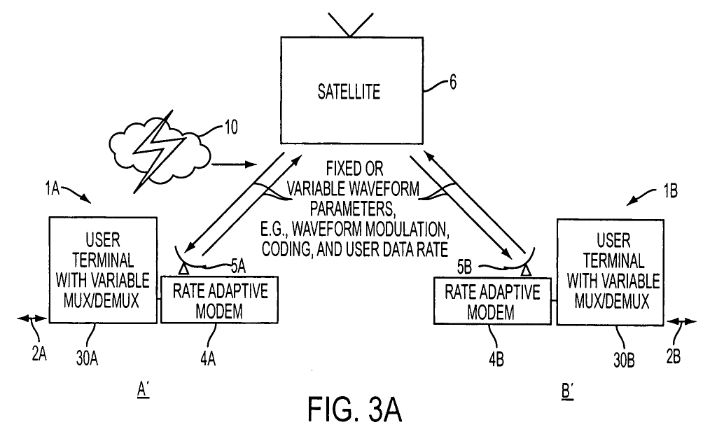

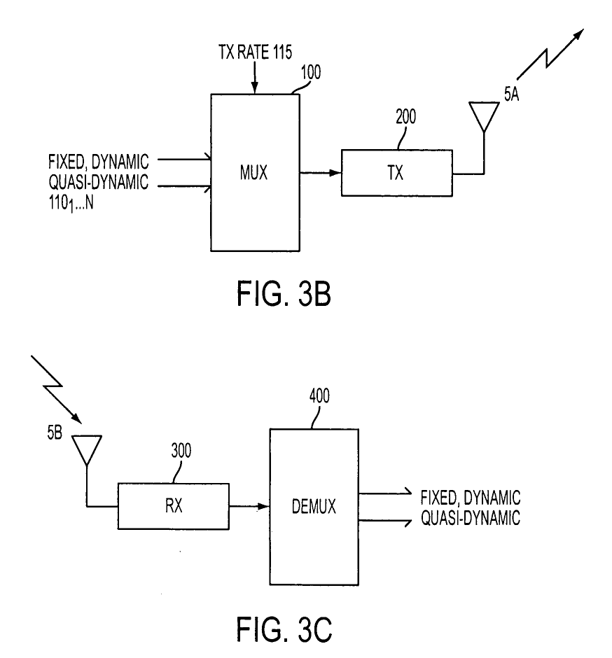

FIG. 3A illustrates a block diagram of a satellite-based communication system similar to that illustrated in FIG. 1, except that the two user terminals 30A, 30B, each located at a respective station A, B, includes a dynamic multiplexer and corresponding dynamic demultiplexer in accordance with the present invention. Otherwise, each user terminal 30A, 30B, has a conventional amplifier and conventional encoding capabilities, and is coupled to a respective fixed or variable rate modem 4A, 4B and a respective antenna 5A, 5B. The waveform used by the modems 4A, 4B is appropriate for general communications. Some examples include transmission through C-band, Ku-band and Ka-band non-generative transponders on geo-stationary satellites. Preferably, but not necessarily, the waveform is coded, e.g., Turbo code, and is modulated, e.g., 16-ary modulation. In a preferred embodiment, the communication system is operable in accordance with ITA techniques and standards.

Notably, although FIG. 3A illustrates a satellite system that necessarily is “wireless,” the present invention may also be incorporated into terrestrial wireless systems. In either case, a rate adaptive multiplexer in user terminal 30A is coupled to a rate adaptive demultiplexer in user terminal 30B by a communications link (in the illustrated example through satellite 6, but also through terrestrial relays or the like). Also, since the link between the rate adaptive multiplexer in user terminal 30A and the rate adaptive demultiplexer in user terminal 30B is bi-directional, the present description of respective functions of rate adaptive multiplexer/demultiplexer combination are applicable to the other rate adaptive multiplexer/demultiplexer combination when it is performing a similar function.

FIG. 3B provides a schematic illustration of a multiplexer 100, having features in accordance with the present invention. The multiplexer 100 receives input data, via a plurality of input channels 110_{l . . . N} at any of a variety of data rates, which may be multiplexed and transmitted by transmitter 200 via the antenna 5A. The input communication channels 110_{l . . . N} to the multiplexer 100 may include (1) input data channels that have fixed data rates that are, for example, operator configured and remain constant throughout a communication session; (2) input data channels that have dynamic data rates which may vary during the communication session based on system conditions; and (3) input data channels that have “quasi-dynamic” data rates. The data rates may also vary during the communication session but the variation may be limited to a predetermined range. The rate for the multiplexer 100 is variable and is set by a rate input 115, either automatically or by an operator input, as illustrated. The multiplexer 100 is stream based and combines data from multiple input data channels to form the bytes for each sub-frame. Some data channels may use a byte interface to the multiplexer 100 while others may use a serial bit interface. The multiplexer 100 converts the serial bit streams of bit-serial channels into serial byte streams by taking 8 consecutive bits and forming one byte. The first bit of the group of eight goes into the MSB position and the last bit goes into the LSB position. Bytes from each of the data streams are sequentially placed into the appropriate positions of each sub-frame. The multiplexer 100 is dynamic, i.e., the parameters controlling the multiplexer 110 may be changed on-line. Preferably, in accordance with an exemplary embodiment, the multiplexer 100 is dynamic regardless of whether ITA is enabled.

FIG. 3C illustrates an arrangement for a user terminal, where signals are received on antenna 5B and provided to a receiver 400, whose output is provided to a demultiplexer 400. The demultiplexer outputs the plurality of data channels, including those having fixed data rates, dynamic data rates and quasi-dynamic data rates.

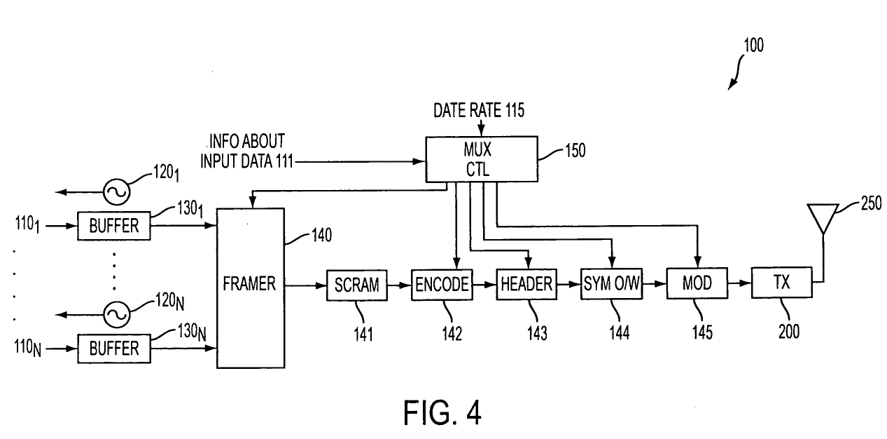

The multiplexer 100 in FIG. 3B is illustrated in greater detail in FIG. 4. As shown, the various input data channels 110_{l . . . N} are first input to respective buffers 130_{l . . . N} for subsequent access by a framing portion 140. The flow of signals on each of the channels 110_{l . . . N} may be individually timed using respective clock signal sources 120_{l . . . N}. In addition, some or all of the input data channels 110_{l . . . N} may be timed by a common clock signal source (not shown). The framing portion 140, which may be controlled by a multiplexer controller 150, is operable to multiplex the data transmitted through the plural input data channels 110_{l . . . N} into a common data stream.

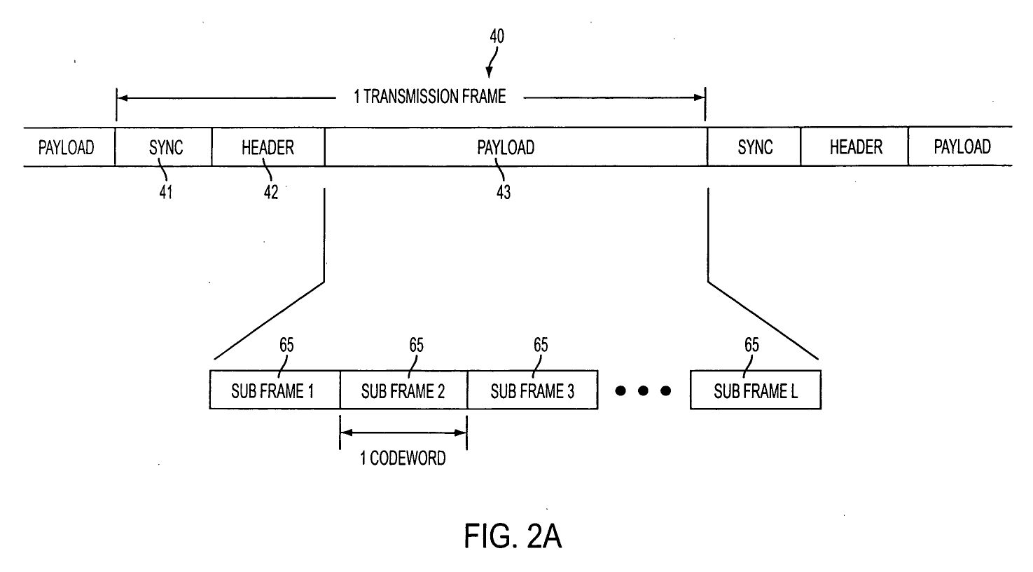

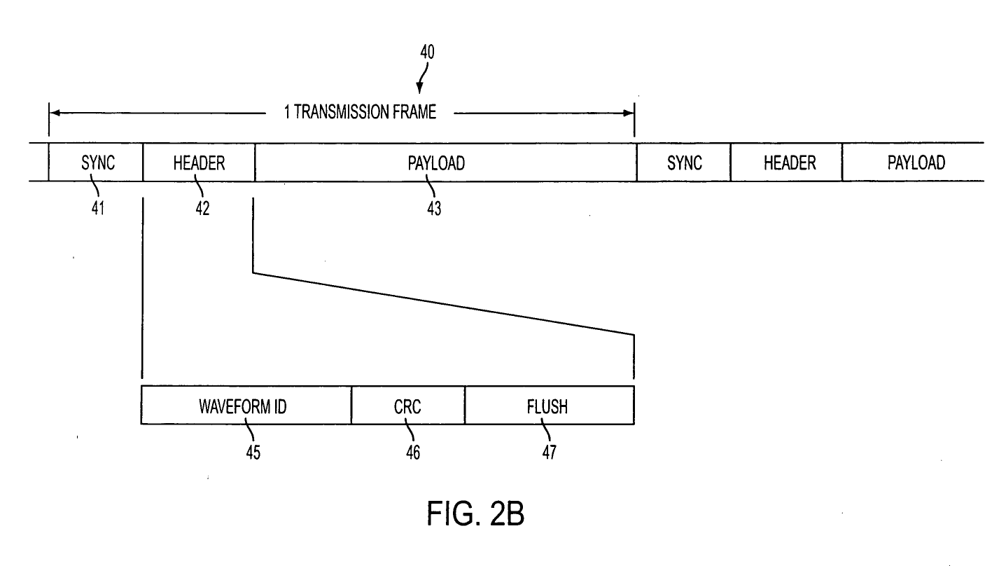

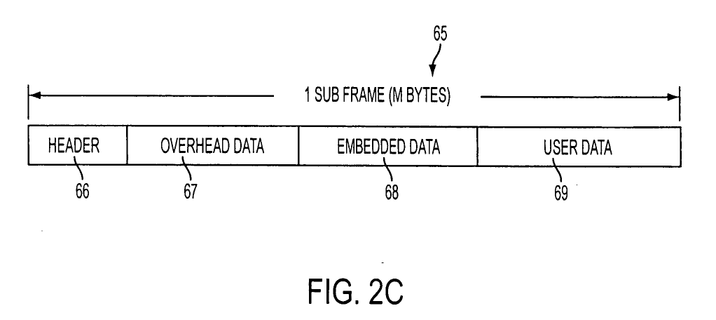

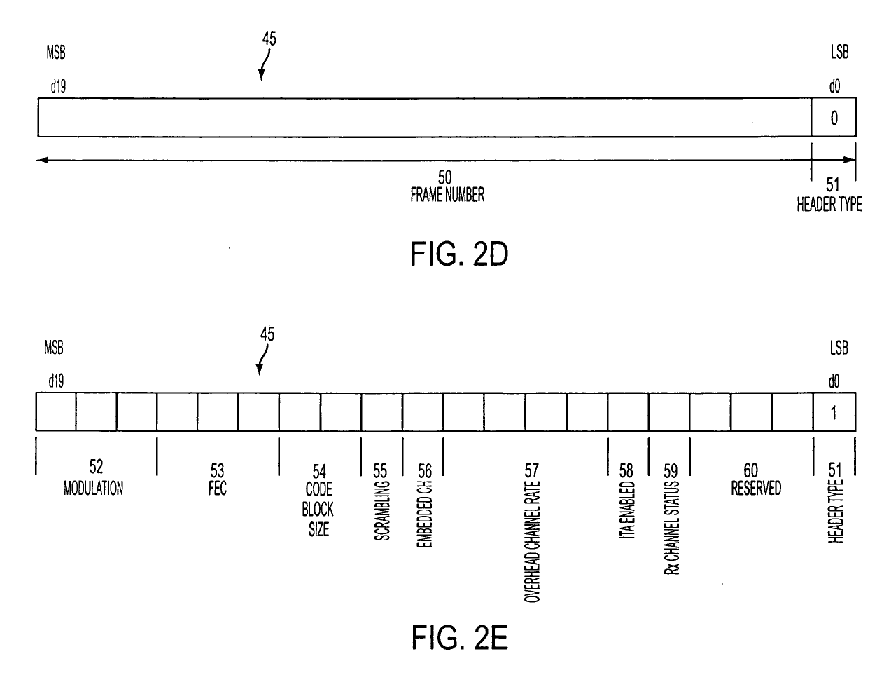

The multiplexed data may be packaged in, for example, a payload section 43 of a transmission frame 40 having the conventional arrangement illustrated in FIG. 2A. As in the conventional arrangement illustrated in FIG. 2B, preferably, but not necessarily, the transmitted waveform from the user terminal contains three types of information, overhead channel data, embedded channel data (when used) and user data. All three types of information may originate at the transmitting modem or elsewhere. The three types of information (i.e., overhead channel data, embedded channel data and user channel data) may be carried in the payload 43 of each transmission frame 40, such that each sub-frame may contain bytes multiplexed from the overhead channel, the embedded channel, and the user data channel. Also, while the modulation and coding may remain the same for all code blocks in a single transmission frame 40, when ITA is enabled (as indicated by ITA enabled bit 58 of waveform 45, as illustrated in FIG. 2D), the modulation and coding parameters as well as the number of symbols (J_{sym}) in the transmission frame 40 may vary from transmission frame to transmission frame. However, preferably, the number of information bits (K) per sub-frame and the number of code blocks (L) per transmission frame 40 remain constant for all transmission frames. The number of information bits (LK) in a transmission frame 40 may be, for example, 65,536 bits for Turbo code configurations and 51,456 bits for TCM configurations.

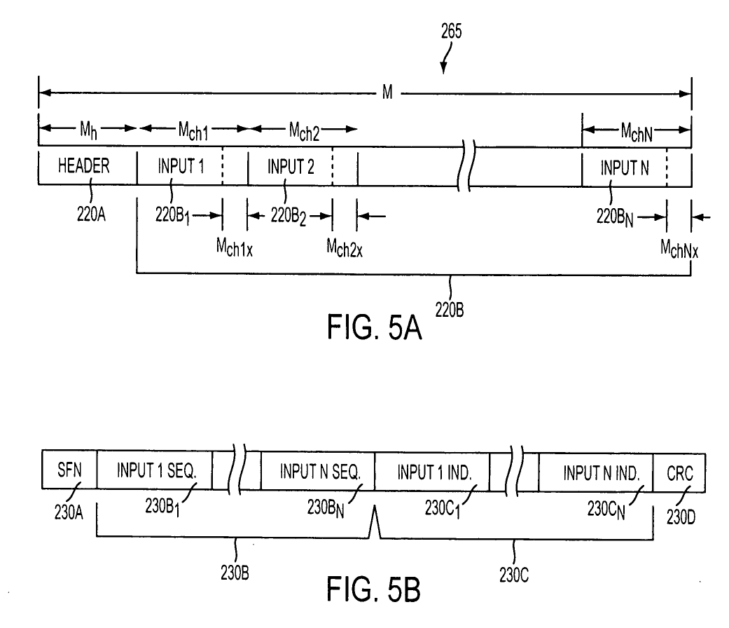

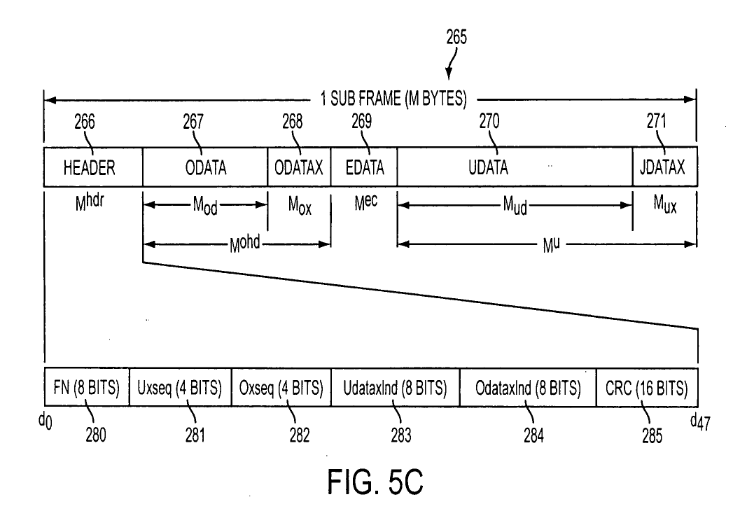

As already noted, but with reference to FIGS. 2A and 5A, the payload section 43 may comprise one or more sub-frames 265, each sub-frame 265 comprising data from at least one of the plural input data channels 110_{l . . . N}, which are coupled to the framer 140. A non-limiting example of a structure for a sub-frame 265, which is generated in accordance with the present invention and is used to carry multiplexed data in accordance with the present invention, is illustrated in FIG. 5A. The sub-frame 265 includes a sub-frame header 220A and data 220B, which comprises data 220Bₗ to 220B_{N} from input data channels 110_{l . . . N}, respectively. The sub-frame header 220A may contain information for de-multiplexing the transmitted data at a receiving terminal 300, which comprises a de-multiplexer 400, as illustrated in FIG. 3B.

More specifically, the composition of a sub-frame header 220A is depicted in FIG. 5B. Each sub-frame header 220A contains a sub-frame sequence number, a sequence number for each fixed rate data channel 230Bₗ-B_{N}, and an “extra” input indication for each fixed rate data channel. If cyclic redundancy check (CRC) is applied to the sub-frame header 220A information, then the sub-frame header 220A may contain a CRC field. 230D.

FIG. 5C illustrates an exemplary structure of sub-frame 265. Each sub-frame 265 comprises a sub-header field 266 with length M^{hdr}, overhead channel data field 267 with length M^{ohd}, embedded channel data field 268 (when used) with length M^{ec} and user channel data field 269 with length M^{u}. The sub-header field 266 is 6 bytes (48 bits) in length and contains the control information for multiplexer 100.

The overhead channel data field 267 comprises an Odata field 270, with length M_{od}, that contains the overhead channel data bytes and an Odatax field 271, with length Mₒₓ, that is either empty or will contain “extra” overhead channel data bytes. The Odatax field 271 is filled with overhead channel data bytes by the transmitting modem when the size of the data being buffered in the overhead channel data input buffer is greater than a predetermined threshold. Otherwise, no overhead channel data bytes are put into this field by the transmitting modem.

The Edata field 268 contains the embedded channel data bytes when the embedded channel is enabled. The indication of whether the embedded channel is used is configured in the embedded channel enabled bit 56 of waveform ID field 45, as illustrated in FIG. 2E.

The user data channel field 269 comprises an Udata field 272 that contains the user channel data bytes and an Udatax field 273 that is either empty or will contain “extra” user channel data bytes. The Udatax field 273 is filled with user channel data bytes by the transmitting modem when the size of the data being buffered in the user channel data input buffer is greater than a predetermined threshold. Otherwise, no user channel data bytes are put into this field by the transmitting modem.

The header field 266 comprises a frame number (FN) 274 that is assigned to each sub-frame. Preferably, but not necessarily, the frame number 274 is eight bits and has a value ranging from 0 to 255. Preferably, the frame number 274 is incremented by one in successive frames.

The header field 266 also comprises a Uxseq field 275 that indicates the sequence number of the Udatax field 273 and, preferably, is incremented by one when Udatax field 275 contains data. Preferably, but not necessarily, the value in the Uxseq field 275 ranges from 0 to 15.

The header field 266 comprises a Oxseq field 276 that indicates the sequence number of the Odatax field 271 and, preferably, is incremented by one when the Odatax field 271 contains data. Preferably, but not necessarily, the value in the Odxseqx field 276 ranges from 0 to 15.

The UdataxInd field 277 in the header 266 indicates whether the Udatax field 273 in the current frame contains data. The value in the UdataxInd field 277 is, for example, 0x00 if it contains data and 0×FF otherwise. Preferably, majority decoding is used on the first 7 bits to determine the indicator status at the receiver, i.e., if the number of 1 bits in the first 7 bits is greater than or equal to 4, then UdataxInd is assumed to be 0xff, otherwise it is assumed to be 0×00.

Similarly, the OdataxInd field 278 indicates whether the Odatax field 271 in the current frame contains data. The value of OdataxInd is, for example, 0x00 if it contains data and 0×FF otherwise. Preferably, majority decoding shall be used on the first 7 bits to determine the indicator status.

Preferably, but not necessarily, a 16-bit CRC is applied to the 32 bits of header information described above using a polynomial procedure. After generation of CRC bits, the header message bits is transmitted in sequence starting at bit position 0 and ending at bit position.

The components of the header field include a frame number (FN) 280, which may be assigned to each sub-frame and preferably is incremented by one (modulo 256) in successive frames. A Uxseq 281 indicates the sequence number of the Udatax field and preferably is incremented by one (modulo 16) when Udatax contains data. The Oxseq 282 Indicates the sequence number of the Odatax field and preferably is incremented by one (module 16) when Odatax contains data. UdataxInd 283 indicates whether the Udatax field in the current frame contains data. The value of UdataxInd is 0x00 if it contains data and is 0xFF otherwise. Majority decoding may be used on the first 7 bits to determine the indicator status. As to OdataxInd 284, the parameter indicates whether the Odatax field in the current frame contains data. The value of OdataxInd is 0x00 if it contains data and is 0xFF otherwise. Majority decoding may be used on the first 7 bits to determine the indicator status. Finally, a 16-bit CRC 285 may be applied to the 32 bits of the header information described above. After generation of CRC bits, the header message bits shall be transmitted in sequence starting at bit position 0 and ending at bit position.

A non-limiting example of a structure for the sub-frame header 220A is illustrated in FIG. 5C. Each sub-frame header 220A may comprise a sub-frame number field 230A, which identifies each sub-frame 210 in a payload section 43, of the type illustrated in FIG. 2A. When, CRC is applied, the sub-frame header 220A also comprises CRC Field 230D. The sub-frame header 220A may also comprise sequence field 230B and indication field 230C. Fields 230B and 230C are described subsequently.

Turning again to the exemplary but non-limiting embodiment of a dynamic multiplexer, as illustrated in FIG. 4, the serial multiplexed data stream from framer 140 is fed to a scrambler 141, which in an exemplary embodiment is a selectable synchronous scrambler that provides randomization of the payload data. In an exemplary embodiment, the scrambling function is selectable, and when scrambling is not selected, this function is bypassed. When scrambling is selected, the information bits of each frame are randomized. An encoder 142, which operates under control of the multiplexer controller 150, can provide Turbocoding, and preferably is supported for all modulations. TCM, with a selectable Reed Solomon outer code, may be provided for 16-APSK modulation. Turbo coding can be applied at selectable code rates of ½, ⅔, ¾, ⅞, and 19/20. Uncoded operation may also be selected. The scrambling and encoding process for the assembled frames is conventional and ensure both security and accuracy, and serve to minimize losses.

The individual frames then have a header appended to them at header unit 143. The header format is shown in FIG. 2B as HEADER 42.

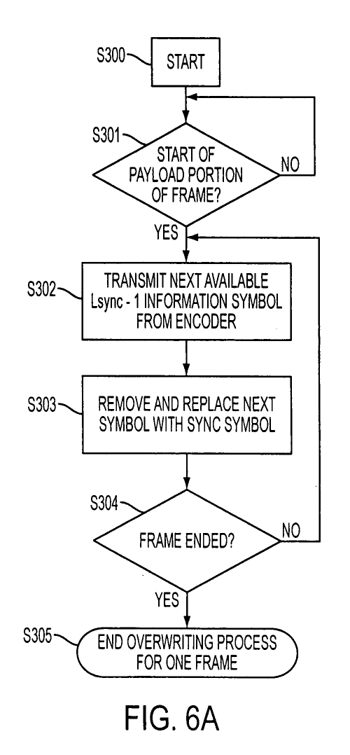

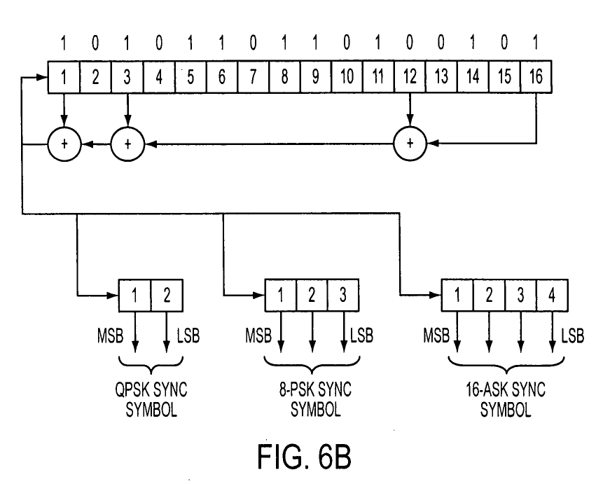

The individual frames then have a sync field appended to them at symbol overwrite (Sym O/W) unit 144. The sync field is shown in FIG. 2B as SYNC 41. The symbol overwrite function is subsequently explained with respect to FIGS. 6A and 6B.

The output of symbol overwrite unit 144 is modulated at modulator 145, which may be a fixed or variable modulator as already explained. Details of an exemplary variable modulator are given in co-pending application to Agarwal et al, entitled Enhanced Bandwidth Efficient Modem, filed concurrently with the present application and assigned to the same assignee as the present application.

Finally, the modulated signal is forwarded by transmitter 200 via antenna 250 to a relay satellite or another receiving antenna in the system.

Control over the operation of framer 140, encoder 142, header unit 143, symbol overwrite unit 144 and modulator 145 is provided by multiplexer controller 150, which has as an input a source of information 111 (such as mapping port numbers to type of data such as fixed, dynamic or quasi-dynamic, etc.) about the input data ports and a data rate selector 115, which may be automatic on the basis of detected environmental conditions or performance parameters, or on the basis of operator input.

In controlling the framing portion 140, the multiplexer controller 150 must account for input data channels 110_{l . . . N} that have a fixed data rate and input data channels 110_{l . . . N} whose data rates may vary. Preferably, but not necessarily, some or all of the input data channels 110 to the framing portion 140 may have a buffer 130_{l . . . N} to accumulate data as the framing portion 140 multiplexes the data from the input data channels 110_{l . . . N}.

The multiplexer controller 150 determines the control parameters, e.g., the number of data bits allocated for each input data channel 110_{l . . . N} in a sub-frame 265 of the type illustrated in FIG. 2A. The control parameters are used when the framing portion 140 multiplexes the data from each input data channel 110_{l . . . N}. The total bit-length of the payload section 43 and/or the sub-frame 265 may be predetermined based on a type of modulation and coding that is used. The control parameters are derived based on a mode of operation of the multiplexer 100. If the multiplexer 100 is utilized in a system where all the input data channel data rates are fixed at respective values for a given communication session (hereinafter “Mode 1”), then the multiplexer controller 150 determines an output symbol rate for the multiplexed information and a set of control parameters appropriate for the input data channel data rates. For example, based on the total number of bits allocated to the payload section or each sub-frame, the multiplexer controller 150 may determine the number of data bits allocated, i.e. bit-length, for each input data channel 110_{l . . . N}. Notably, the determination may be based on byte-length as well. Thus, for purposes of a generic definition of specifying data arrangements, including both byte-length and bit-length, such measurements are referred to as “data-length.”

Preferably, but not necessarily, in the Mode 1 of operation, the allocation of the bit-length for each input data channel 110_{l . . . N} may be based on a ratio of the data rate of the respective input data channel and a summation of the data rates of all the unallocated input data channels, as input to the multiplexer controller 150 as data 115. For example, if the total bit-length for sub-frame 265 is M and the allocated sub-frame header length is Mₕ, then, for a system with three inputs, the bit-length M_{ch1} for the first input data channel will be: M_{ch1}=(M−Mₕ)*(R_{ch1}/(R_{ch1}+R_{ch2}+R_{ch3})), where R_{ch1} is the data rate for the first channel, R_{ch2} is the data rate for the second input data channel and R_{ch3} is the data rate for the third input data channel. The bit-length M_{ch2} for the second input data channel will be: M_{ch2}=(M−Mₕ−M_{ch1})*(R_{ch2}/(R_{ch2}+R_{ch3})). In this example, the bit-lengths M_{ch1}, and M_{ch2} will be respectively rounded up to the smallest integer values that are greater than or equal to the actual values calculated for M_{ch1} and M_{ch2}. Because only one channel remains in the example, the remaining unallocated bits of M are assigned to bit length M_{ch3} for the third input data channel and M_{ch3} will be: M_{ch3}=M−M_{ch1}−M_{ch2}−Mₕ.

When the multiplexer 100 is utilized in a system where a data rate of at least one input data channel may vary in a given communication session (“Mode 2”), the multiplexer controller 150 determines the control parameters based on a desired symbol rate of the transmission channel. For example, based on the total number of bits allocated to sub-frame 265, the multiplexer controller 150 may determine the number of data bits allocated, i.e. bit-length, for each input data channel.

Preferably, but not necessarily, in Mode 2, the output symbol rate is kept constant. In this case, the allocation of the bit-length for each input data channel may be based on (1) the size of the transmission frame 40 in symbols and (2) a ratio of the data rate of the respective input data channel and the desired output symbol rate R_{sym}. For example, if the total bit-length for the sub-frame 65 is M and the allocated sub-frame header length is Mₕ, then, for a system with three inputs, the bit-length M_{ch1} for the first input data channel will be: M_{ch1}=(J_{sym}/L)*R_{ch1}/R_{sym}, where J_{sym} is the transmission frame 40 size in symbols and L is the number of sub-frames 65. The bit-length M_{ch2} for the second input data channel will be: M_{ch2}=(J_{sym}/L)*(R_{ch2}/R_{sym}. Similar to Mode 1, the bit-lengths for M_{ch1} and M_{ch2} will be rounded up. Therefore, to account for the remaining unallocated bits of M, the bit-length M_{ch3} for the third input data channel will be: M_{ch3}=M−Mₕ−M_{ch1}−M_{ch2}.

Preferably, but not necessarily, a portion of the bit-length M_{chN} allocated for an input data channel 110_{N} may be reserved as an auxiliary data field having bit-length M_{chNx}. The framing portion 140 may use the auxiliary data field to insert an extra data bit (or bits if the length of M_{chNx} is greater than one bit) based on an overflow condition regarding the respective input data channel 110_{N}, e.g., whether data in the respective input buffer 130_{l . . . N} has accumulated to a predetermined point.

Preferably, in Mode 1, the auxiliary data field length M_{chNx} for an input data channel 110_{N} is based on the size of sub-header 65 in symbols and a ratio of the respective input data channel data rate R_{N} and a symbol rate R_{sym} for one of the channels. For example, the auxiliary data field length may be set such that M_{chNx}=M_{chN}−Fn((R_{N}/R_{sym})*(J_{sym}/L)), where Fn (x) represents a rounded down value that is the largest integer value less than or equal to x.

Preferably, but not necessarily, in Mode 2, the auxiliary data field length M_{chNx} for an input data channel 110_{N} is equal to 1 bit.

Preferably, but not necessarily, when the auxiliary bit-length field for an input data channel is used, i.e., contains data, the respective sequence field 230B (FIG. 5B) of sub-frame header 220A is incremented by one. Preferably, but not necessarily, in addition to updating the sequence number in the appropriate sequence field 230B_{N}, the respective indication field 230C_{N} is updated to indicate that the respective auxiliary bit-length field M_{chNx} in the current sub-frame 65 contains data.

Preferably, but not necessarily, the sub-frame header 266 has an indication field 230C_{N} only when the respective input data channel 110_{N} has an auxiliary bit-length field M_{chNx}. Preferably, but not necessarily, the indication field 230C_{N} has a value of 0x00 when the respective auxiliary bit-length field M_{chNx} contains data and 0xFF otherwise. Preferably, but not necessarily, majority decoding is used at the receiver on the first seven bits of indication field 230C_{N} to determine the indicator status.

In a multiplexer consistent with the present invention, because the sub-frame header 220A information content is error-protected using a CRC code, any errors in the header field 220A of the sub-frame 265 will be detected at a very high probability. However, in a rare event that a CRC error check passes for undetected errors, the information content is further protected by the integrity checks of individual data fields, e.g., consistency in the sub-frame numbering in the SFN field 230A and consistency in the sequence numbers in the fields 230B. In addition, the indication fields 230C are heavily protected from transmission errors using a 4-out-of-7 majority decoding.

If the CRC detects errors, the sub-frame header 220A information will be lost. However, the sequence numbers in fields 230B in the next sub-frame 265 provide information on the data contents (i.e., data or idle) in the previous sub-frame, thus guaranteeing the bit count integrity (BCI). Accordingly, depending on the length of sequence fields 230B, a device using a multiplexer consistent with the present invention can tolerate a large number of successive sub-frame header errors. For example, if the sequence fields have a length of 4 bits, then the multiplexer can tolerate up to 15 consecutive sub-frame header errors. A larger number of sub-frame header losses can be supported by increasing the lengths of the sequence number fields.

Whether operating in Mode 1 or in Mode 2, the framing portion 140 sends the multiplexed data to the chain of scrambler 141, encoder 142, header unit 143, symbol unit 144 and modulator 145, as illustrated in FIG. 4. Finally, the transmission frame may be transmitted by the transmitter 110 for reception by a receiving terminal 300 comprising a de-multiplexer 310 that separates the data in the payload section 4 into the respective channel data.

Receiver operation is very similar to the transmitter, except that the order of operations is reversed. As can be understood from FIG. 4, which applies to the transmitter, at the receiver the received data is demodulated at unit 15, the symbol overwriting function 144 is used to maintain synchronization, the frame header is processed in unit 143, the sub-frames are decoded in unit 142 and data is de-scrambled at unit 141. The de-framer unit 10 performs the extraction of bits from sub-frame 65 into the respective data channels. The computation of the lengths of the various sub-fields in sub-frame 65 is performed in an identical manner as the transmitter. Extracted data for each data channel is inserted into the respective buffers 130-1 to 130-N. The checksum for the header is computed and compared with the received checksum field 285. If the checksum is not valid, then further processing of header fields is skipped. A local next expected sequence number is maintained for each data channel. If the sequence number 230BN for a data channel is not equal to the next expected sequence number, then the difference between the two numbers is computed and that many bits (or bytes) of zeroes are inserted into the data buffer. Next, the auxiliary indication field 230C_{N} for each data channel is examined. If its value is 0×ff, then data from the corresponding auxiliary data field is extracted and added to the channel buffer. If the indication field 230C_{N} is 0x00, then data from the corresponding auxiliary data field is discarded. Preferably, majority decoding is used on the first 7 bits of the indicator field 230C_{N}, i.e., if the number of 1 bits in the first 7 bits is greater than or equal to 4, then it is assumed to be 0xff, otherwise it is assumed to be 0x00. Next, the next expected sequence number is set to the received sequence number plus one using modulo arithmetic.

In an exemplary embodiment applicable to a system capable of operating in an ITA mode, calculation of the multiplexer parameters for multiplexer 100 depends on ITA mode parameters and capabilities, for example, the use of a rate adaptive modem. If ITA is not enabled (Mode 1), the operator enters the user channel data rate, R_{b}^{u}, and the overhead channel data rate, R_{b}^{ohd}, and the modem determines the symbol rate, R_{sym}, and the multiplexer parameters. Preferably, the embedded channel data rate, R_{b}^{ec}, is 4 kbps when the embedded channel is required and 0 when not required. Preferably, the multiplexer calculations when ITA is not enabled are as follows:

$$\begin{matrix}{M}^{ec} = ⌈ \frac{{R}_{b}^{ec}}{{R}_{b}^{t}} ( M - {M}^{hdr} ) ⌉ & ( Equation 1 ) \\ If Embedded channel enabled ; & \\ {M}^{ec} = 0 & ( Equation 2 ) \\ If Embedded channel is disabled ; & \\ {M}^{ohd} = ⌈ \frac{{R}_{b}^{ohd}}{{R}_{b}^{t}} ( M - {M}^{hdr} ) ⌉ ; & ( Equation 3 ) \\ {M}^{u} = M - {M}^{hdr} - {M}^{ohd} - {M}^{ec} ; & ( Equation 4 ) \\ {M}_{od} = ⌊ 0.999 \cdot \frac{{R}_{b}^{ohd}}{{R}_{b}^{u}} {M}^{u} ⌋ ; & ( Equation 5 )\end{matrix}$$

Mₒₓ=M^{ohd}−M_{od}; (Equation 6)

Mᵤₓ=1; (Equation 7)

and M_{ud}=M^{u}−1, (Equation 9)

where R_{b}^{t}=R_{b}^{u}+R_{b}^{ohd}+R_{b}^{ec}, the function ┌x┐ is the smallest integer greater than or equal to x, and the function └x┘ is the largest integer less than or equal to x. The function ┌x┐ serves to force the symbol rate to be an integer value. If an integer valued symbol rate is not needed, the rounding up of the symbol rate may be eliminated. In this case, Mᵤₓ is set to 0 and M_{ud}=M^{u}.

The symbol rate is then determined by,

$${R}_{sym} = ⌈ \frac{{J}_{sym}}{8 {LM}^{u}} {R}_{b}^{u} ⌉ ; \qquad ( Equation 10 )$$

Equations for the parameters J_{sym} and L depend on the type of coding, e.g., Turbo code and TCM.

For example, for turbo code, the turbo code block size, K, is selected based upon the sum of the information rates of the user data channel, the overhead channel, and the embedded channel, i.e., (R_{b}^{u}+R_{b}^{ohd}+R_{b}^{ec}). For sum data rates less than 1024 kbps, K will be 1024 bits. For sum data rates greater than or equal to 1024 kbps but less than 4096 kbps, K will be equal to 4096 bits. For sum data rates greater than or equal to 4096 kbps, K will be equal to 16,384 bits. When ITA is enabled, the block size K will be selected based upon the maximum possible sum data rate considering all possible modulation and coding choices that are allowed in the adaptation process. This block size will be used for all modulation and coding values during the adaptation process. The relationship between sub-frame size and transmission frame size parameters is summarized in Table 2.

TABLE 2
Summary of Sub-frame and Frame Size
parameters for Turbo Coded Modes

| | | Bits/Trans. Frame | |
|---|---|---|---|
| K | L | (KL) | J_{sym} |
| 1024 | 64 | 65,536 | See Below |
| 4096 | 16 | 65,536 | See Below |
| 16,384 | 4 | 65,536 | See Below |

The frame size in symbols is determined by

J_{sym}=L·N_{sym}+400, (Equation 11)

where N_{sym} is the number of symbols in 1 codeword. Table 2 defines N_{sym} as a function of the block size (K), the code rate (r), and modulation type.

TABLE 3
Number of Symbols per Codeword (N_{sym})

| | | Code Rate | | | | | |
|---|---|---|---|---|---|---|---|
| Modulation | Block Size (K) | ½ | ⅔ | ¾ | ⅞ | 19/20 | Uncoded |
| BPSK | 1024 | 2048 | 1536 | 1368 | 1172 | 1080 | 1024 |
| BPSK | 4096 | 8192 | 6144 | 5464 | 4684 | 4312 | 4096 |
| BPSK | 16384 | 32768 | 24576 | 21848 | 18728 | 17248 | 16384 |
| QPSK | 1024 | 1024 | 768 | 684 | 586 | 540 | 512 |
| QPSK | 4096 | 4096 | 3072 | 2732 | 2342 | 2156 | 2048 |
| QPSK | 16384 | 16384 | 12288 | 10924 | 9364 | 8624 | 8192 |
| 8-PSK | 1024 | 684 | 512 | 456 | 392 | 360 | 342 |
| 8-PSK | 4096 | 2732 | 2048 | 1822 | 1562 | 1438 | 1366 |
| 8-PSK | 16384 | 10924 | 8192 | 7282 | 6242 | 5750 | 5462 |
| 16-APSK | 1024 | 512 | 384 | 342 | 294 | 270 | 256 |
| 16-APSK | 4096 | 2048 | 1536 | 1366 | 1172 | 1078 | 1024 |
| 16-APSK | 16384 | 8192 | 6144 | 5462 | 4682 | 4312 | 4096 |

Trellis coded modulation (TCM) may be applied to the 16-APSK modulation. As with turbo code, the sub-frame size (K) is not a configurable parameter with TCM. The relationship between the sub-frame size (K), the number of codewords per transmission frame (L), the number of information bits in a frame (KL), and the number of flush symbols in a frame (n_{flush}_{_{—}}_{sym}^{TCM}) is defined below in Table 4.

TABLE A-3
Summary of Sub-frame and Frame Size Parameters for TCM Mode

| Inner | | | | | |
|---|---|---|---|---|---|
| Code | Outer Code | K | L | KL | n_{flush}_{_{—}}_{sym}^{TCM} |
| r = ¾ | None | 1608 | 32 | 51,456 | 3 |
| r = ¾ | RS[219, 201] | 1608 | 32 | 51,456 | 3 |
| r = ⅞ | None | 1608 | 32 | 51,456 | 6 |
| r = ⅞ | RS[219, 201] | 1608 | 32 | 51,456 | 6 |
| Uncoded | None | 1608 | 32 | 51,456 | 0 |

Table 4. Summary of Sub-frame and Frame Size Parameters for TCM Mode

The transmission frame size, in symbols, for a TCM data frame is determined by,

$${J}_{sym} = ⌈ \frac{KL}{4 r} ⌉ + {n}_{flush\_sym}^{TCM} + 400$$

where r is the composite code rate, which is the product of the inner code rate and the outer code.

When ITA is enabled (Mode 2), the operator enters the symbol rate, R_{sym}, and the overhead channel data rate, R_{b}^{ohd}, and the modem determines the and user channel data rate, R_{b}^{u}, and the multiplexer parameters. The embedded channel data rate, R_{b}^{ec}, is 4 kbps when the embedded channel is required and 0 when not required. The multiplexer calculations are as follows:

$$\begin{matrix}{M}^{ec} = ⌈ \frac{{J}_{sym} {R}_{b}^{ec}}{8 {LR}_{sym}} ⌉ & ( Equation 12 ) \\ If Embedded channel is enabled ; & \\ {M}^{ec} = 0 & ( Equation 13 ) \\ If Embedded channel is not enabled ; & \\ {M}^{ohd} = ⌈ \frac{{J}_{sym} {R}_{b}^{ohd}}{8 {LR}_{sym}} ⌉ ; & ( Equation 14 )\end{matrix}$$

M^{u}=M−M^{hdr}−M^{ohd}−M^{ec}; (Equation 15)

Mₒₓ=1; (Equation 16)

M_{od}=M^{ohd}−1; (Equation 17)

Mᵤₓ=1; (Equation 18)

and M_{ud}=M^{u}−1, (Equation 19)

The function └x┘ serves to force the symbol rate to be an integer value. If an integer valued user bit rate is not needed, the rounding down of the user data rate can eliminated. In this case, Mᵤₓ is set to 0 and M_{ud}=M^{u}.

The user channel data rate is then determined by,

$${R}_{b}^{u} = ⌊ \frac{8 {LM}^{u}}{{J}_{sym}} {R}_{sym} ⌋ \qquad ( Equation 20 )$$

Preferably, during ITA, the above calculations are performed every time the modulation and code rate are changed.

To enable operation with high Doppler dynamics, some waveforms will have symbols in the payload of the ITA frame that are periodically removed and replaced with sync symbols. This process, which is illustrated in FIG. 6A, can be performed by the unit 144 in FIG. 4 at the rate of 1 sync symbol per L_{sync}−1 information symbols. At the start of the payload portion of each ITA frame (S301), the first L_{sync}−1 symbols from the encoder will be transmitted as previously generated. In the next step (S302), the next symbol in the encoder output stream is removed and replaced (overwritten) in the stream with a sync symbol. In a subsequent step (S303), the next L_{sync}−1 symbols out of the encoder stream will be then transmitted as generated. Then in step S304, the next symbol out of the encoder stream will be removed and replaced with a sync symbol. As illustrated by the feedback loop, this process continues throughout the entire ITA frame. Notably, this overwriting process does not alter the symbol rate, R_{sym}, of the stream.

When a sync symbol needs to be generated, it shall be generated by clocking the liner feedback shift register shown in FIG. 6B register m times. The value of m is 2, 3, or 4 for QPSK, 8-PSK, and 16-ASK respectively. The shift register initialization sequence value 0xADA5. This initialization sequence is the same as the final state of the shift register. The phasing of the symbol overwriting and the initial contents of the sync symbol generator shall be reset at the beginning of each ITA frame.

At the receiver, the received frames with data symbols and added sync symbols are demultiplexed, decoded and assembled with enhanced accuracy into reconstructed signals from the multiple data sources.

A multiplexing apparatus and method described above have a number of unique features for providing reliable, dynamic, and flexible operation of a transmission system. For a given set of waveform parameters (modulation, FEC coding, a user channel data rate or symbol rate, etc.), a transmission frame structure and multiplexer/demultiplexer configurations are uniquely defined (i.e., the multiplexer configuration parameters, M). These parameters can be directly communicated between the two end modems to implement a coherent transmission system. By way of example and without limitation, FIG. 2E shows the contents of the frame header, which is sent from a transmitting station to a receiving station. Further, the header fields in FIGS. 5B and 5C contains information that is sent from a transmitting station to a receiving station, which is used by the demultiplexing operation at the receiving station, so that compatibility is achieved. Thus, through at least one of these frame headers, parameters relevant to achieving a desired level of synchronization are shared so that they are resident in the multiplexers and demultiplexers of two communicating stations.

When ITA is enabled, an internal control mechanism, i.e., the multiplexer parameters M, can be dynamically calculated/changed to adapt to transmission link conditions without a loss of data.

Similarly, a multiplexing apparatus and method consistent with the present invention can also be used to effectively mitigate data loss during ship-board antenna handover. When an antenna handover occurs, the transmission link will be briefly interrupted (a few microseconds to a few milliseconds) due to switching from one antenna to another. Data loss during handover may be mitigated using interleaving (shore to ship) and replicated data transmission (ship to shore). The proposed multiplexing scheme allows dynamic control of transmission data rates based on transmit buffer occupancy while resolving an ambiguity of replicated data blocks at the demodulator.

In addition, if the transmission frame unique word (UW) is lost, the demodulator operates based on the internal frame timing for a certain period of time (flywheel period). Depending on the demodulator clock accuracy, sub-frame timing can be maintained for a long time even under UW losses, and sub-frame header information can be correctly processed. Thus, robust error protection mechanisms provided for the sub-frame header will provide a good BCI even in severely degraded link conditions.

Although the illustrative, non-limiting embodiment of the invention described above uses a constant overhead channel rate, a dynamic multiplexer consistent with the present invention also supports different clock sources with different timings for the user data channel and the overhead data channel. Because individual data rates are either input or calculated, the present invention can support a dynamic overhead channel rate and multiple user data rates, each having a different clock source with a different timing.

A multiplexing apparatus and method consistent with the present invention supports synchronous timing in which the demodulator output data clock is synchronous to the modulator input data clock. Plesiochronous timing can be implemented by a demodulator buffer which absorbs the frequency difference between the demodulator receive data clock and demodulator output data clock. The size of a plesiochronous buffer is determined by the relative accuracy of the two clocks and an average time interval between buffer pointer adjustments. A multiplexer consistent the present invention also supports asynchronous timing as illustrated for the embedded channel data.

Illustrative, non-limiting embodiments have been explained above and are shown. However, the present invention is not limited to the preferred embodiment described above, and it is apparent that variations and modifications by those skilled in the art can be effected within the spirit and scope of the present invention defined in the appended claims.

For example, although this description focuses on a multiplexing apparatus and method for a specific transmission frame structure, user channel data and overhead channel data rates and transmission format (e.g., ITA), the present invention is not limited to illustrated embodiment and can be applied to a wide range of other applications (with or without modifications). These applications include not only satellite and terrestrial wireless systems but also may include terrestrial wired networks to implement reliable dynamic transmission systems.

While the present invention has been described in accordance with certain specific embodiments, it is not limited thereto. It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A communication system comprising:
a first station and a second station in communication over a wireless communications link,
wherein, said first station is operative during a communication session to assemble signals from multiple data sources into a common data stream and to transmit said data stream as frame-based communication signals to said second station,
wherein said second station is operative at least to receive said communication signals and reconstruct said signals from multiple data sources, and
wherein said first station comprises a dynamically configurable multiplexer that is operative during a communication session (1) to generate said common data stream by multiplexing said signals from multiple data sources in accordance with a plurality of control parameters and assemble said signals according to frames, (2) to dynamically modify said plurality of control parameters in accordance with changes in wireless link conditions and (3) to generate control signals identifying modifications to said control parameters, and
wherein said first station is operative to transmit to said second station said signals assembled according to frames and said control signals.

2. The communications system as recited in claim 1, wherein said second station is operative at least to disassemble a data stream received over said communications link into signals from multiple sources and comprises a de-multiplexer that is operative (1) to receive said transmitted control signals reflecting modifications to said plurality of parameters, (2) to dynamically modify said plurality of parameters in accordance with said control signals, and (3) to demultiplex and reconstruct said signals from multiple sources using said modified control parameters.

3. The communications system as recited in claim 1, wherein said multiplexer is operative in a first mode and a second mode to determine said control parameters,
wherein said first mode comprises operation under conditions where all the input data channel data rates are fixed at respective values for a communication session and said multiplexer has an output symbol rate for the multiplexed information and is operative in accordance with control parameters that correspond to the input data channel data rates, and
wherein said second mode comprises operation under conditions where the data rate of at least one input data channel varies for a communication session and the control parameters are based on a specified symbol rate of a transmission channel.

4. The communications system as recited in claim 3, wherein in said first mode, the allocation of the bit-length for an input data channel is based on a ratio of the data rate of a respective input data channel and a summation of the data rates of all unallocated input data channels.

5. The communications system as recited in claim 4, wherein the total bit-length of a frame or portion thereof is predetermined based on a type of modulation and coding.

6. The communications system as recited in claim 3, wherein said multiple data sources comprise sources of at least two of (1) data rates that are fixed during a communication session, (2) dynamic data rates that vary during a communication session, and (3) quasi-dynamic data rates that vary during the communication session but the variation is limited to a predetermined range.

7. The communications system as recited in claim 6 wherein an output symbol rate is constant and the allocation of data-length for each input data channel is based on the size of a transmission frame and a ratio of the data rate of the respective input data channel and said output symbol rate.

8. The communications system as recited in claim 3, wherein a portion of the data-length allocated for an input data channel is an auxiliary data field useable for overflow conditions.

9. The communications system as recited in claim 1, wherein said first station comprises means for periodically removing symbols in a frame and replacing said symbols with sync symbols.

10. The communications system as recited in claim 9, wherein said second station is operative to reconstruct said signals from multiple data sources using said transmitted data symbols.

11. A dynamic multiplexer operative in a communication system having at least a first station and a second station in communication over a wireless communications link, said multiplexer comprising:
a plurality of input channels, each receiving an input data stream from a respective one of a plurality of data sources,
a framer receiving data from said plurality of input channels and for assembling signals from said plurality data sources into a common frame-based data stream, and
a controller, responsive to information about data at said plurality of input channels to control said framer to generate said common data stream by multiplexing said signals from said plurality of data sources in accordance with a plurality of control parameters and assemble said signals according to frames, said control parameters being modifiable in accordance with features of said plurality of data sources, and to generate control signals identifying modifications to said control parameters.

12. The dynamic multiplexer as recited in claim 11, wherein said multiplexer is operative in a first mode and a second mode to determine said control parameters,
wherein said first mode comprises operation under conditions where all the input data channel data rates are fixed at respective values for a communication session and said multiplexer has an output symbol rate for the multiplexed information and is operative in accordance with control parameters that correspond to the input data channel data rates, and
wherein said second mode comprises operation under conditions where the data rate of at least one input data channel varies for a communication session and the control parameters are based on a specified symbol rate of a transmission channel.

13. The dynamic multiplexer as recited in claim 12, wherein in said first mode, the allocation of the data-length for an input data channel is based on a ratio of the data rate of a respective input data channel and a summation of the data rates of all unallocated input data channels.

14. The dynamic multiplexer as recited in claim 13, wherein the total data-length of a frame or portion thereof is predetermined based on a type of modulation and coding.

15. The dynamic multiplexer as recited in claim 14, wherein said multiple data sources comprise sources of at least two of (1) data rates that are fixed during a communication session, (2) dynamic data rates that vary during a communication session, and (3) quasi-dynamic data rates that vary during the communication session but the variation is limited to a predetermined range.

16. The dynamic multiplexer as recited in claim 15 wherein an output symbol rate is constant and the allocation of data-length for each input data channel is based on the size of a transmission frame and a ratio of the data rate of the respective input data channel and said output symbol rate.

17. The dynamic multiplexer as recited in claim 12, wherein a portion of the data-length allocated for an input data channel is an auxiliary data field useable for overflow conditions.

18. The dynamic multiplexer as recited in claim 11, further comprising a plurality of clocks assigned respectively to a channel.

19. A method of transmitting communications information between a first station and a second station in a frame-based communication over a wireless communications link, wherein, said first station is operative during a communication session at least to assemble signals from multiple data sources into a common data stream and to transmit to said second station said data stream as a plurality of frames, each frame having a plurality of symbols assembled in a payload, said method comprising:
transmitting a first plurality of symbols as previously generated and output by an encoder in a frame of an output stream;
removing a next symbol in the encoder output stream and replacing said next symbol in the stream with a sync symbol; and
repeating said transmitting and removing steps throughout an entire frame.

20. The method of claim 19 wherein phasing of the symbol overwriting and the initial contents of the sync symbol generator is reset at the beginning of each frame
